(19) United States
(12) Patent Application Publication
(10) Pub. No.: US 2013/0295349 A1
(43) Pub. Date: Nov. 7, 2013

(54) TRANSPARENT CONDUCTIVE FILM WITH PRESSURE-SENSITIVE ADHESIVE LAYER, METHOD FOR PRODUCING SAME, AND TOUCH PANEL

(71) Applicants: Mizue Yamasaki, Ibaraki-shi (JP); Tomotake Nashiki, Ibaraki-shi (JP); Hideo Sugawara, Ibaraki-shi (JP)

(72) Inventors: Mizue Yamasaki, Ibaraki-shi (JP); Tomotake Nashiki, Ibaraki-shi (JP); Hideo Sugawara, Ibaraki-shi (JP)

(73) Assignee: NITTO DENKO CORPORATION, Ibaraki-shi, Osaka (JP)

(21) Appl. No.: 13/994,199

(22) PCT Filed: Dec. 13, 2011
(86) PCT No.: PCT/JP2011/078787

§ 371 Date: Jun. 14, 2013

(30) Foreign Application Priority Data
Dec. 15, 2010 (JP) 2010-279066

(51) Int. Cl. G06F 3/044; H01B 13/00; C09J 7/02

(52) U.S. Cl. CPC G06F 3/044; C09J 7/0207; H01B 13/0036
USPC 428/203; 428/195.1; 216/20

(57) ABSTRACT

The transparent conductive film is capable of preventing a situation in which level differences formed due to patterning exceed a design value, even when the film base used is a thin film base having a thickness of 110 μm or less or even when the transparent conductive layer has been crystallized by heating. Transparent conductive film with a pressure-sensitive adhesive layer comprises: a film base, a transparent conductive layer laminated on one surface of the film base and which is patterned and a pressure-sensitive adhesive layer laminated on the other surface of the film, wherein the film base has a thickness of 10 to 110 μm, a total thickness of the film base and the pressure-sensitive adhesive layer is 30 to 300 μm, and the pressure-sensitive adhesive layer has a storage modulus measured at 23° C. of 1.2×10⁵ or more and less than 1.0×10⁷ Pa.

### TECHNICAL FIELD

The present invention relates to a transparent conductive film with a pressure-sensitive adhesive layer, which has a transparent conductive layer on one surface of a film base and a pressure-sensitive adhesive layer on the other surface of the film base, and a method for producing thereof. The transparent conductive film with a pressure-sensitive adhesive layer according to the present invention is suitably used for an electrode substrate of an input device of a capacitive touch panel. Touch panels including the transparent conductive film with a pressure-sensitive adhesive layer according to the present invention can be used in, for example, liquid crystal monitors, liquid crystal televisions, digital video cameras, digital cameras, mobile phones, hand-held video game machines, car navigators, electronic papers, organic electro-luminescent displays and so on.

### BACKGROUND ART

Conventionally, as transparent conductive films, those formed by laminating a transparent conductive layer (e.g. ITO film) on a transparent film base have been known. The transparent conductive film is used as a transparent conductive film with a pressure-sensitive adhesive layer in which on a side of the film base on which the transparent conductive layer is not provided, a pressure-sensitive adhesive layer is provided for lamination with other members.

When the transparent conductive film or transparent conductive film with a pressure-sensitive adhesive layer is used for an electrode substrate of a capacitive touch panel, the transparent conductive film, the transparent conductive layer of which is patterned, is used (Patent Document 1). Such a transparent conductive film with a pressure-sensitive adhesive layer, which has a patterned transparent conductive layer, is used in such a manner as to be laminated with other transparent conductive films and so on, and is suitably used in a multi-touch-type input device that can be operated with two or more fingers at the same time.

However, when the transparent conductive layer is patterned, level differences are generated in the transparent conductive layer due to patterning, so that a difference between a patterned part and a non-patterned part becomes evident, leading to deterioration of appearance. That is, when external light from the visibility surface side is reflected at the transparent conductive layer, or internal light from the display element side passes through the transparent conductive layer, presence/absence of patterning becomes evident, leading to deterioration of appearance.

Thus, a transparent conductive film has been proposed in which the pattern of a transparent conductive layer is made hardly visible by forming the transparent conductive layer with an anchor coat layer interposed, the anchor coat layer composed of a high-refractive index layer and a low-refractive index layer, and adjusting the thickness of each anchor coat layer (Patent Document 2). Further, a transparent conductive film has been proposed in which the pattern of a transparent conductive layer is made hardly visible by laminating on the transparent conductive film a layer which reduces the light transmittance, such as a colored layer (Patent Document 3). Further, it is contemplated to reduce a difference in light transmittance and a difference in reflectance between a patterned part and a non-patterned part of a transparent conductive layer, so that the patterning of the transparent conductive layer is made hardly visible.

### PRIOR ART DOCUMENTS

### Patent Documents

Patent Document 1: JP-A-2009-076432
Patent Document 2: JP-A-2010-015861
Patent Document 3: JP-A-2010-027391

### SUMMARY OF THE INVENTION

### Problems to be Solved by the Invention

Deterioration of appearance due to the patterning is noticeable particularly when the transparent conductive film is heated for crystallizing the transparent conductive layer. This is considered to be because a large wave-like undulation occurs in the transparent conductive film due to heat treatment, so that level differences of the transparent conductive layer formed due to the patterning exceed a design value (for example, the level difference is equal to or more than 5 times the design value when the film base is a polyethylene terephthalate film). It has been found that deterioration of appearance due to level differences of the transparent conductive layer generated due to the patterning becomes more noticeable as the thickness of the film base decreases. Particularly, when the thickness of the film base is 110 μm or less, the aforementioned level differences become too large for practical use. That is, it has been found that deterioration of appearance resulting from level differences of the transparent conductive layer generated due to patterning is not particularly significant for a transparent conductive film with a pressure-sensitive adhesive layer in which a film base having a large thickness is employed, but it becomes evident as the thickness of the transparent conductive film with a pressure-sensitive adhesive layer is reduced.

It is an object of the present invention to provide: a transparent conductive film with a pressure-sensitive adhesive layer, which has a transparent conductive layer on one surface of a film base, and a pressure-sensitive adhesive layer on the other surface of the film base, and which is for use in capacitive touch panels, the transparent conductive film being capable of preventing a situation in which level differences formed due to patterning exceed a design value, leading to deterioration of appearance, even when the film base used is a thin film base having a thickness of 110 μm or less or even when the transparent conductive layer has been crystallized by heating; and a method for producing the transparent conductive film.

Further, an object of the present invention is to provide a capacitive touch panel using the transparent conductive film with a pressure-sensitive adhesive layer.

### Means for Solving the Problems

The present inventors have eagerly conducted studies for solving the aforementioned problems, and resultantly completed the present invention by inventing the transparent conductive film with a pressure-sensitive adhesive layer described below.

That is, the present invention relates to a transparent conductive film with a pressure-sensitive adhesive layer, which is for use in a capacitive touch panel, the transparent conductive film including a film base, a transparent conductive layer laminated on one surface of the film base and which is patterned and a pressure-sensitive adhesive layer laminated on the other surface of the film, wherein the film base has a thickness of 10 to 110 μm, a total thickness of the film base and the pressure-sensitive adhesive layer is 30 to 300 μm, and the pressure-sensitive adhesive layer has a storage modulus measured at 23° C. of 1.2×10⁵ or more and less than 1.0×10⁷ Pa.

The transparent conductive film with a pressure-sensitive adhesive layer, wherein the transparent conductive layer is laminated on the film base with at least one undercoat layer interposed therebetween, can be used.

The transparent conductive film with a pressure-sensitive adhesive layer, wherein the pressure-sensitive adhesive layer is laminated on the film base with an oligomer prevention layer interposed therebetween, can be used.

The transparent conductive film with a pressure-sensitive adhesive layer is particularly useful when the patterned transparent conductive layer is crystallized.

The present invention relates to a method for producing the transparent conductive film with a pressure-sensitive adhesive layer, wherein the method includes: a step A of providing a laminated body which has a transparent conductive layer laminated on one surface of a film base having a thickness of 10 to 110 μm and which has on the other surface of the film base a pressure-sensitive adhesive layer which has a storage modulus measured at 23° C. of 1.2×10⁵ or more and less than 1.0×10⁷ Pa and which is controlled so that a total thickness of the film base and the pressure-sensitive adhesive layer is 30 to 300 μm; and a step B of patterning the transparent conductive layer in the laminated body obtained in the step A.

The production method can further include a step C of heating the laminated body obtained in the step A at 60 to 200° C. to crystallize the transparent conductive layer in the laminated body. When the method includes the crystallization step C, it is preferred to carry out the crystallization step C after carrying out the step B of patterning the laminated body obtained in the step A.

Further, the present invention relates to a capacitive touch panel including at least one aforementioned transparent conductive film with a pressure-sensitive adhesive layer.

### Effect of The Invention

A transparent conductive film having a patterned transparent conductive layer has different linear expansion coefficients in a patterned part and a non-patterned part of a transparent conductive layer. Further, it has been found that expansion and shrinkage behaviors are different in the patterned part and the non-patterned part of the transparent conductive film due to the difference in linear expansion coefficient when the transparent conductive film is heated for crystallizing the transparent conductive layer and then cooled. It is considered that such expansion and shrinkage behaviors occurring due to a difference in linear expansion coefficient develop a large wave-like undulation in the transparent conductive film itself, so that level differences of the transparent conductive layer formed by the patterning are noticeable, leading to deterioration of appearance.

In a transparent conductive laminated body with a pressure-sensitive adhesive layer according to the present invention, the film base is a thin film base having a thickness of 10 to 110 μm, and level differences that exceed a design value are easily generated in a patterned transparent conductive layer, but by using a pressure-sensitive adhesive layer that satisfies a storage modulus within a predetermined range, occurrence of a wave-like undulation in a transparent conductive film can be suppressed to prevent a situation in which level differences formed due to patterning exceed a design value even when the film is heated.

Further, in the transparent conductive laminated body with a pressure-sensitive adhesive layer according to the present invention, the film base is thin, and therefore the amount of moisture arising from the film base and vapors of a plasticizer and the like can be reduced when the transparent conductive layer is formed on the film base, so that a transparent conductive layer of high quality can be formed. The transparent conductive laminated body with a pressure-sensitive adhesive layer according to the present invention is controlled so that the total thickness of the film base and the pressure-sensitive adhesive layer is 30 to 300 μm while a thin film base is used. When the transparent conductive laminated body with a pressure-sensitive adhesive layer according to the present invention is laminated and used, and applied for an electrode substrate of a multi-touch type touch panel, by controlling the total thickness of the film base and the pressure-sensitive adhesive layer as described above, the degree of design freedom for a gap between electrodes is increased, so that a transparent conductive film suitable for a capacitive touch panel can be obtained with high productivity.

According to a method for producing a transparent conductive film with a pressure-sensitive adhesive layer according to the present invention, productivity is high because a thin film base is used, and it is not required to add separately the step for improving appearance because a pressure-sensitive adhesive layer that satisfies a storage modulus within the predetermined range is used. Thus production efficiency can be kept high.

### BRIEF DESCRIPTION OF THE DRAWINGS

FIG. 1 is a sectional view showing one embodiment of a transparent conductive film with a pressure-sensitive adhesive layer according to the present invention.

FIG. 2 is a sectional view showing one embodiment of a transparent conductive film with a pressure-sensitive adhesive layer according to the present invention.

FIG. 3 is a sectional view showing one embodiment of a transparent conductive film with a pressure-sensitive adhesive layer according to the present invention.

FIG. 4 is a sectional view showing one embodiment of a transparent conductive film with a pressure-sensitive adhesive layer according to the present invention.

FIG. 5 is a sectional view showing one embodiment of a transparent conductive film with a pressure-sensitive adhesive layer according to the present invention.

FIG. 6 is a sectional view showing one example of a structure of a touch panel using as an electrode substrate a transparent conductive film with a pressure-sensitive adhesive layer according to one embodiment of the present invention.

FIG. 7 is a sectional view showing one example of a structure of a touch panel using as an electrode substrate a transparent conductive film with a pressure-sensitive adhesive layer according to one embodiment of the present invention.

FIG. 8 is a sectional view showing one example of a structure of a touch panel using as an electrode substrate a transparent conductive film with a pressure-sensitive adhesive layer according to one embodiment of the present invention.

FIG. 9 is one example of a plan view of a transparent conductive film with a pressure-sensitive adhesive layer according to the present invention.

### MODE FOR CARRYING OUT THE INVENTION

Embodiments of a transparent conductive film with a pressure-sensitive adhesive layer according to the present invention will be described below with reference to the drawings.

FIG. 1 is a sectional view showing one embodiment of a transparent conductive film with a pressure-sensitive adhesive layer according to the present invention. A transparent conductive film with a pressure-sensitive adhesive layer 11 shown in FIG. 1 has a patterned transparent conductive layer 2 on one surface of a film base 1, and a pressure-sensitive adhesive layer 3 on the other surface. The transparent conductive layer 2 includes a patterned part a in which the transparent conductive layer is formed and a non-patterned part in which the transparent conductive layer is not formed. Further, a separator S can be bonded to the pressure-sensitive adhesive layer 3.

In the transparent conductive film with a pressure-sensitive adhesive layer according to the present invention, the linear expansion coefficient of the patterned part a of the transparent conductive layer 2 is preferably larger than the linear expansion coefficient of the non-patterned part b of the transparent conductive layer.

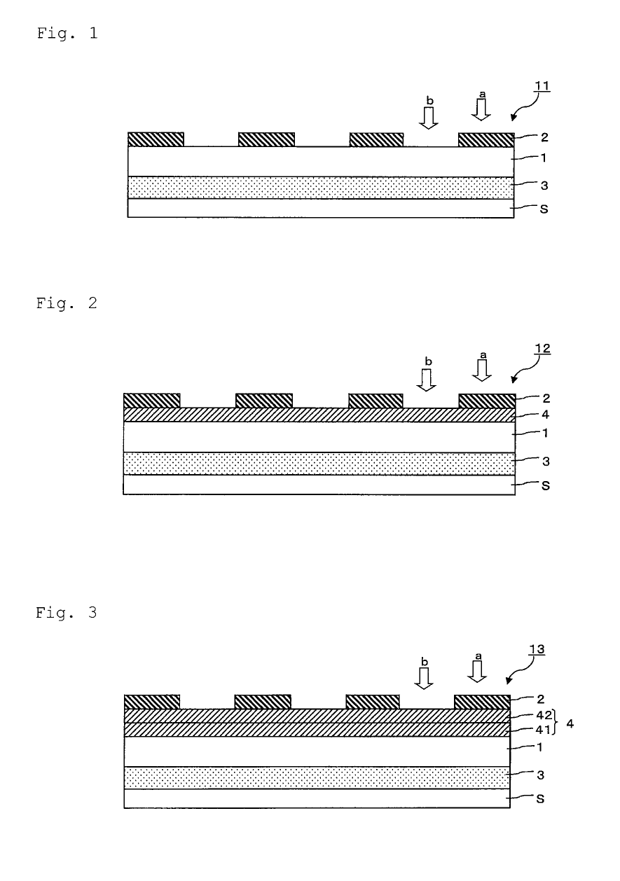

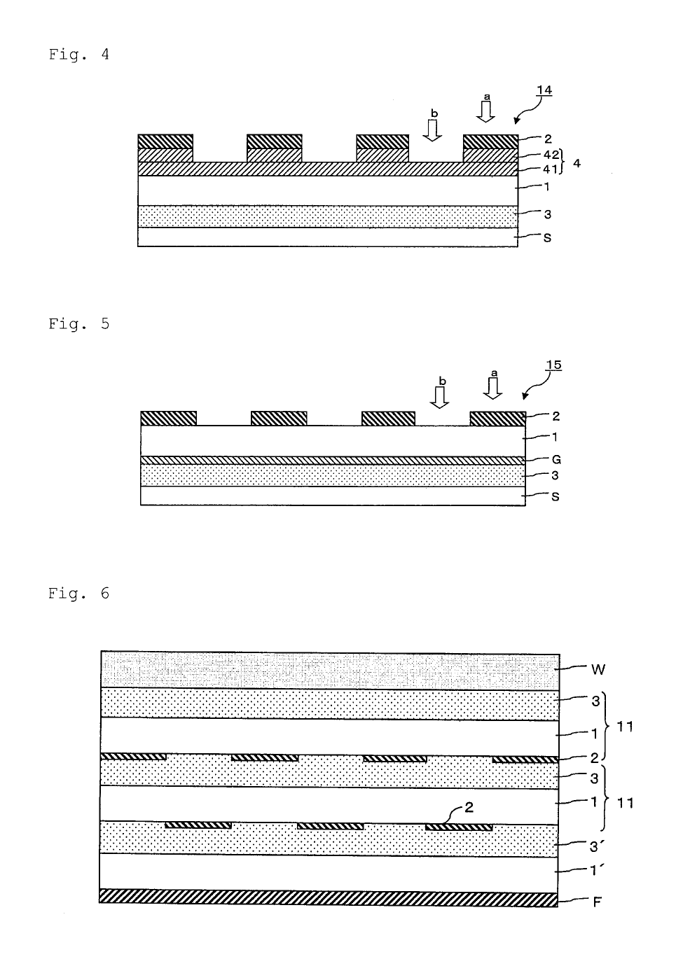

FIGS. 2 to 4 each are a sectional view showing a transparent conductive film with a pressure-sensitive adhesive layer according to another embodiment of the present invention. Transparent conductive films with a pressure-sensitive adhesive layer 12 to 14 each are an example of a case where in the transparent conductive film with a pressure-sensitive adhesive layer 11 shown in FIG. 1, the patterned transparent conductive layer 2 is provided on one surface of the film base 1 with an undercoat layer 4 interposed therebetween. FIG. 2 shows a case where the transparent conductive film has the undercoat layer 4 of one layer. The undercoat layer according to the present invention may be a multi-layer structure of two or more layers. FIGS. 3 and 4 each show a case where the undercoat layer is composed of two layers.

In FIGS. 3 and 4, undercoat layers 41 and 42 are provided in this order from the film base 1 side. In the transparent conductive film with a pressure-sensitive adhesive layer 12 shown in FIG. 3, the undercoat layer 42 is exposed through the non-patterned part b. In the transparent conductive film with a pressure-sensitive adhesive layer 13 shown in FIG. 4, the undercoat layer 42 at the largest distance from the film base 1 is patterned like the transparent conductive layer 2. In the transparent conductive film with a pressure-sensitive adhesive layer 13, the undercoat layer 41 is exposed through the non-patterned part b and the non-patterned part of the undercoat layer 42.

In FIGS. 3 and 4, a case has been described where the undercoat layer is composed of two layers, but the undercoat layer may be composed of three or more layers. When the undercoat layer is composed of three or more layers, it is preferred that the first undercoat layer from the film base 1 side is exposed. The case where the undercoat layer is composed of at least two layers is preferred in that control is performed so that a difference in reflectance between the patterned part and the non-patterned part is kept small. In particular, when the undercoat layer is composed of at least two layers, it is preferred that the undercoat layer at the largest distance from the transparent film base 1 (undercoat layer 42 when the undercoat layer 4 is composed of two layers as shown in FIG. 4.) is patterned like the transparent conductive layer in that control is performed so that a difference in reflectance between the patterned part and the non-patterned part is kept small.

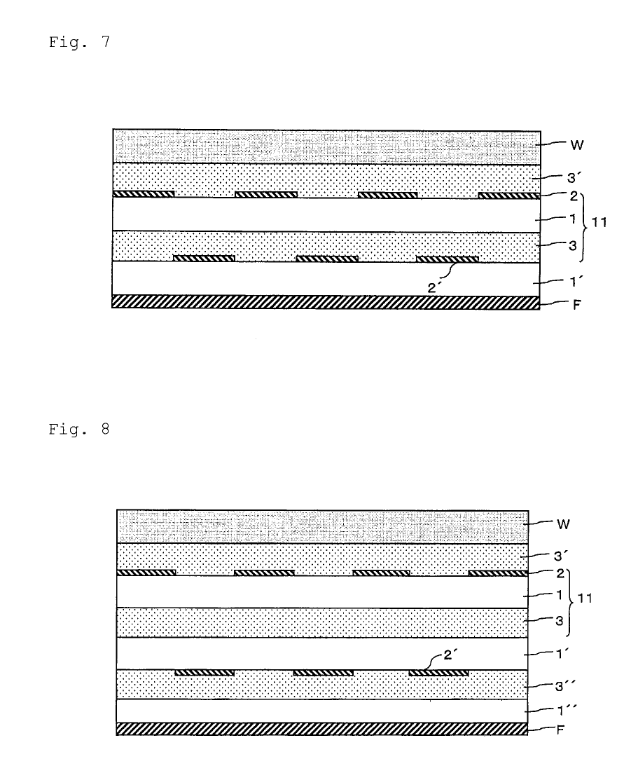

FIG. 5 is a sectional view showing a transparent conductive film with a pressure-sensitive adhesive layer according to another embodiment of the present invention. Transparent conductive film with a pressure-sensitive adhesive layer 15 is an example of a case where in the transparent conductive film with a pressure-sensitive adhesive layer 11 shown in FIG. 1, the pressure-sensitive adhesive layer 3 is provided on one surface of the film base 1 with an oligomer layer G interposed therebetween. It is to be noted that, in FIG. 5, an aspect of the transparent conductive film with a pressure-sensitive adhesive layer 11 shown in FIG. 1 is described, but in the transparent conductive films with a pressure-sensitive adhesive layer 12 to 14 shown in FIGS. 2 to 4, the oligomer layer G may be provided as well.

The film base 1 is not particularly limited, but various kinds of plastic films having transparency may be used. Examples of the material thereof include a polyester-based resin, an acetate-based resin, a polyether sulfone-based resin, a polycarbonate-based resin, a polyamide-based resin, a polyimide-based resin, a polyolefin-based resin, a (meth)acryl-based resin, a polyvinyl chloride-based resin, a polyvinylidene chloride-based resin, a polystyrene-based resin, a polyvinyl alcohol-based resin, a polyarylate-based resin and a polyphenylene sulfide-based resin. Among them especially preferable are a polyester-based resin, a polycarbonate-based resin and a polyolefin-based resin.

Further, mention is made of a polymer film described in JP-A-2001-343529 (WO 01/37007), for example, a resin composition which contains (A) a thermoplastic resin having a substituted and/or unsubstituted imide group on a side chain and (B) a thermoplastic resin having a substituted and/or unsubstituted phenyl and a nitrile group on a side chain. Specifically, a polymer film of a resin composition containing an alternating copolymer composed of isobutylene and N-methylmaleimide, and an acrylonitrile/styrene copolymer can be used.

The thickness of the film base 1 is 10 to 110 μm. The present invention is satisfactory for the thickness, even in the case of a thin film having a thickness of 10 to 80 μm, or even 10 to 60 μm, or more even 10 to 30 μm. When the film base 1 is made thin so as to have a thickness in the above-described range, the total thickness of the transparent conductive film with a pressure-sensitive adhesive layer decreases and in addition, for example, when the transparent conductive layer 2 is formed by a sputtering method, the amount of volatile components generated from the interior of the film base 1 becomes low, and as a result, a transparent conductive layer having reduced defects can be formed.

The surface of the film base 1 may be subjected beforehand to an etching treatment or under-coating treatment such as sputtering, corona discharge, flame treatment, ultraviolet ray irradiation, electron beam irradiation, chemical formation or oxidization. Thereby, adhesion to the film base 1 of the transparent conductive layer 2 or the undercoat layer 4 provided thereon can be improved. The film base may be freed from dust and cleaned by solvent cleaning or ultrasonic cleaning as necessary before the transparent conductive layer 2 or the undercoat layer 4 is provided.

The constituent material of the transparent conductive layer 2 is not particularly limited, and a metal oxide of at least one metal selected from the group consisting of indium, tin, zinc, gallium, antimony, titanium, silicon, zirconium, magnesium, aluminum, gold, silver, copper, palladium and tungsten is used. The metal oxide may further contain metal atoms shown in the above-mentioned group as necessary. For example, indium oxide containing tin oxide, tin oxide containing antimony, and the like are preferably used.

The thickness of the transparent conductive layer 2 is not particularly limited, but is preferably 10 nm or more, more preferably 15 to 40 nm, further preferably 20 to 30 nm. If the thickness of the transparent conductive layer 2 is 15 nm or more, it is easy to have a satisfactory surface resistance of 1×10³Ω/□ or less. Further, it is easy to form a continuous film. If the thickness of the transparent conductive layer 2 is 40 nm or less, a layer having higher transparency can be formed.

The method for forming the transparent conductive layer 2 is not particularly limited, and a conventionally known method can be employed. Specific examples thereof include a vacuum deposition method, a sputtering method and an ion plating method. An appropriate method can also be employed according to a required thickness.

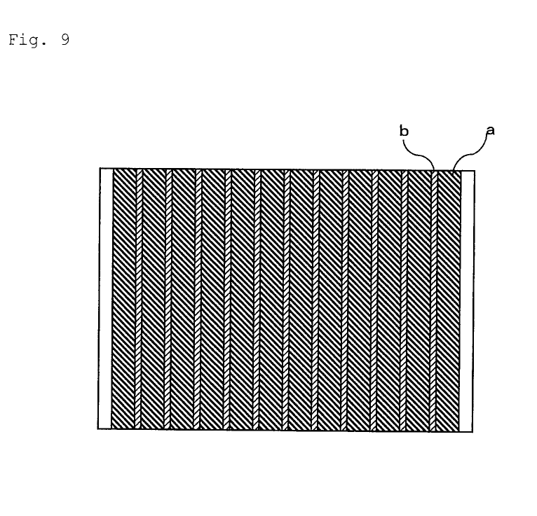

The transparent conductive layer 2 is patterned. Patterning of the transparent conductive layer 2 is performed by etching. For a shape of patterning, any certain shape can be formed according to an application for which a certain form of transparent conductive film with a pressure-sensitive adhesive layer is used. A patterned part and a non-patterned part are formed by patterning of the transparent conductive layer 2, and examples of the shape of the patterned part include a stripe form and a square form. FIG. 9 is a plan view of the transparent conductive film with a pressure-sensitive adhesive layer shown in FIG. 1. As shown in FIG. 9, in the transparent conductive layer 2, the patterned part a and the non-patterned part b are formed in a stripe form. It is to be noted that, in FIG. 9, the width of the patterned part a is larger than the width of the non-patterned part b, but the present invention is not limited thereto.

A difference in refractive index between the transparent conductive layer 2 and the undercoat layer 4 described later is preferably 0.1 or more. The refractive index of the transparent conductive layer 2 is normally about 1.95 to 2.05.

The undercoat layer 4 can be formed from an inorganic substance, an organic substance or a mixture of an inorganic substance and an organic substance. Examples of the inorganic substance include inorganic substances such as NaF (1.3), Na₃AlF₆ (1.35), LiF (1.36), MgF₂ (1.38), CaF₂ (1.4), BaF₂ (1.3), SiO₂ (1.46), LaF₃ (1.55), CeF₃ (1.63) and Al₂O₃ (1.63) [the numerical value within the parenthesis for the above-mentioned each material is a refractive index]. Among them, SiO₂, MgF₂, Al₂O₃ and the like are preferably used. In particular, SiO₂ is suitable. Besides the inorganic substances described above, a composite oxide containing about 10 to 40 parts by weight of cerium oxide and about 0 to 20 parts by weight of tin oxide with respect to indium oxide can be used.

Examples of the organic substance include an acryl resin, a urethane resin, a melamine resin, an alkyd resin, a siloxane-based polymer and an organic silane condensate. At least one of these organic substances is used. As the organic substance, in particular, it is desirable to use a thermosetting resin formed of a mixture of a melamine resin, an alkyd resin and an organic silane condensate.

The undercoat layer 4 can be provided between the film base 1 and the transparent conductive layer 2, and does not have a function as a conductive layer. That is, the undercoat layer 4 is provided as a dielectric material layer that provides insulation between the base and the patterned transparent conductive layer 2. Therefore, the undercoat layer 4 normally has a surface resistance of 1×10⁶Ω/□ or higher, preferably 1×10⁷Ω/□ or higher, further preferably 1×10⁸Ω/□ or higher. The upper limit of the surface resistance of the undercoat layer 4 is not particularly limited. The upper limit of the surface resistance of the undercoat layer 4 is generally a measurement limit, which is about 1×10¹³Ω/□, but the surface resistance may be higher than 1×10¹³Ω/□.

The undercoat layer 4 preferably has such a refractive index that a difference between the refractive index of the transparent conductive layer 2 and the refractive index of the undercoat layer is 0.1 or more. It is preferred that the difference between the refractive index of the transparent conductive layer 2 and the refractive index of the undercoat layer is 0.1 or more and 0.9 or less, further preferably 0.1 or more and 0.6 or less. It is preferred that the refractive index of the undercoat layer 4 is normally 1.3 to 2.5, preferably 1.38 to 2.3, further preferably 1.4 to 2.3.

It is preferred that the first undercoat layer from the film base 1 (e.g. an undercoat layer 41) is formed of an organic substance in that the transparent conductive layer 2 is patterned by etching. When the undercoat layer 4 is composed of one layer (e.g. the undercoat layer 4 shown in FIG. 2), it is preferred that the undercoat layer 4 is formed of an organic substance.

When the undercoat layer 4 is composed of at least two layers, it is preferred that at least the undercoat layer at the largest distance from the film base 1 (e.g. an undercoat layer 42) is formed of an inorganic substance in that the transparent conductive layer 2 is patterned by etching. When the undercoat layer 4 is composed of three or more layers, it is preferred that undercoat layers above the second undercoat layer from the film base 1 are also formed of an inorganic substance.

The undercoat layer formed of an inorganic substance can be formed by a dry process such as a vacuum deposition method, a sputtering method and an ion plating method, or a wet process by (coating method) or the like. The inorganic substance that forms the undercoat layer is preferably SiO₂ as described previously. In the wet process, a SiO₂ film can be formed by applying silica sol or the like.

Thus, when two layers are provided as the undercoat layer 4, it is preferred that the first undercoat layer 41 is formed of an organic substance and the second undercoat layer 42 is formed of an inorganic substance.

The thickness of the undercoat layer 4 is not particularly limited, but is normally about 1 to 300 nm, preferably 5 to 300 nm, from the viewpoint of optical design and an effect of preventing generation of an oligomer from the film base 1. It is to be noted that, when two or more layers are provided as the undercoat layer 4, the thickness of each layer is about 5 to 250 nm, preferably 10 to 250 nm.

The pressure-sensitive adhesive layer 3 is used for incorporating a transparent conductive film into an input device of a touch panel or the like to be fixed therein. The pressure-sensitive adhesive layer 3 has a storage modulus at 23° C. of 1.2×10⁵ or more and less than 1.0×10⁷ Pa. The pressure-sensitive adhesive layer 3 having such a storage modulus is used in such a manner as to be laminated on the film base 1, so that patterning level differences of the patterned transparent conductive layer are significantly suppressed because a force works to keep the film base 1 flatter when the film base is bonded with a rigid base. The storage modulus of the pressure-sensitive adhesive layer 3 is preferably 1.5×10⁵ Pa or more, further preferably 2.0×10⁵ Pa or more. On the other hand, the storage modulus of the pressure-sensitive adhesive layer 3 is preferably 5.0×10⁶ Pa or less. If the storage modulus of the pressure-sensitive adhesive layer 3 is less than 1.2×10⁵ Pa, patterning level differences may not be sufficiently reduced, while if the storage modulus is 1.0×10⁷ Pa or more, the adhesion properties of the pressure-sensitive adhesive layer may be impaired.

The storage modulus of the pressure-sensitive adhesive layer 3 can be appropriately increased or reduced by controlling the type and Tg of a base polymer used in the pressure-sensitive adhesive (for example, the value of the storage modulus can be made higher by increasing Tg of the base polymer), and the type and the blending amount of a crosslinking agent used therein (for example, the value of the storage modulus can be made higher by increasing the blending amount of the crosslinking agent). For example, the storage modulus is increased by increasing the ratio of the crosslinking agent, and the storage modulus is reduced by decreasing the crosslinking agent.

The pressure-sensitive adhesive layer 3 can be used without particular limitation as long as it satisfies the above-described storage modulus. Specifically, for example, one having as a base polymer a polymer such as an acryl-based polymer, a silicone-base polymer, a polyester, a polyurethane, a polyamide, a polyvinyl ether, a vinyl acetate/vinyl chloride copolymer, a modified polyolefin, an epoxy-based polymer, a fluorine-based polymer, or a rubber-based polymer such as natural rubber or synthetic rubber can be appropriately selected and used. In particular, an acryl-based pressure-sensitive adhesive is preferably used in terms of being excellent in optical transparency, showing adhesive characteristics such as moderate wettability, cohesiveness and tackiness, and also being excellent in weather resistance and heat resistance.

As the acryl-based pressure-sensitive adhesive, for example, a pressure-sensitive adhesive, which contains as a base polymer a block copolymer or graft copolymer having a (meth)acryl-based polymer (A) segment having a glass transition temperature of 0° C. or lower and a (meth)acryl-based polymer (B) segment having a glass transition temperature of 40° C. or higher, can be used.

The glass transition temperature of the (meth)acryl-based polymer (A) segment is 0° C. or lower, and allows the pressure-sensitive adhesive layer of the present invention to exhibit adhering strength by imparting wettability with an adherend and flexibility as a pressure-sensitive adhesive at a normal working temperature. The glass transition temperature of the (meth)acryl-based polymer (A) segment is preferably −20° C. or lower, more preferably −30° C. or lower, and normally the glass transition temperature is −70° C. or higher. It is preferable that the glass transition temperature of the (meth)acryl-based polymer (A) segment is −20° C. or lower in that durability under a low temperature condition is excellent.

The glass transition temperature of the (meth)acryl-based polymer (B) segment is 40° C. or higher, and allows the pressure-sensitive adhesive layer of the present invention to exhibit excellent adhesion properties and durability by imparting cohesive strength at a normal working temperature. The glass transition temperature of the (meth)acryl-based polymer (B) segment is preferably 80° C. or higher, more preferably 100° C. or higher, and normally the glass transition temperature is 150° C. or lower. It is preferable that the glass transition temperature of the (meth)acryl-based polymer (B) segment is 80° C. or higher in that durability under a high temperature condition is excellent.

For the block copolymer or graft copolymer, a block copolymer or graft copolymer having the (meth)acryl-based polymer (A) segment and (meth)acryl-based polymer (B) segment can be used. For example, provided that A represents the (meth)acryl-based polymer (A) segment and B represents the (meth)acryl-based polymer (B) segment, for example, diblock copolymers represented by A-B; triblock copolymers represented by A-B-A, B-A-B; or tetrablock copolymers, or combinations of more number of As and Bs may be shown as an example of the block copolymer. As the graft copolymer, mention is made of a graft copolymer having A or B as a main chain and having as a side chain a segment different from the main chain. When there are two or more As and Bs, the As and Bs may be the same, or may be different, respectively.

As a base polymer of the pressure-sensitive adhesive of the present invention, the block copolymer or graft copolymer can be used, but the block copolymer is preferable because the glass transition temperature and the molecular weight are easily controlled, and among block copolymers, a triblock copolymer represented by B-A-B is preferably used because adhesion properties and bulk physical properties are more easily controlled.

The weight average molecular weight of the block copolymer or graft copolymer is 50000 to 300000, and is preferably 60000 to 250000, more preferably 70000 to 200000, from the viewpoint of both durability and reworkability.

The molecular weight distribution (Mw/Mn) of the block copolymer or graft block copolymer is 1.0 to 1.5, and is preferably 1.0 to 1.4, more preferably 1.0 to 1.3, from the viewpoint of high cohesive strength at a high temperature and excellent durability.

As long as the (meth)acryl-based polymer (A) segment contains a (meth)acrylic acid alkyl ester as a main component of a monomer unit, and its glass transition temperature is 0° C. or less, the type of monomer units and the composition of components thereof are not particularly limited, but it is preferred that the (meth)acrylic acid alkyl ester constitutes 50% by weight or more, and further 60% by weight or more, of total monomer units in that the glass transition temperature is controlled.

Examples of the (meth)acrylic acid alkyl ester as a main monomer unit of the (meth)acryl-based polymer (A) segment include (meth)acrylic acid alkyl esters with the alkyl group having 1 to 18 carbon atoms. Specific examples thereof include (meth)acrylic acid alkyl esters such as methyl (meth)acrylate, ethyl (meth)acrylate, propyl (meth)acrylate, n-butyl (meth)acrylate, t-butyl (meth)acrylate, n-hexyl (meth)acrylate, cyclohexyl (meth)acrylate, 2-ethylhexyl (meth)acrylate, n-octyl (meth)acrylate, lauryl (meth)acrylate, tridecyl (meth)acrylate and stearyl (meth)acrylate. They may be used alone or in combination of two or more thereof. The (meth)acryl-based polymer (A) segment is preferably an acryl-based polymer segment having an acrylic acid alkyl ester as a main monomer unit. As the main monomer unit, acrylic acid alkyl esters with the alkyl group having 1 to 9 carbon atoms, such as propyl acrylate, n-butyl acrylate, 2-ethylhexyl acrylate and n-octyl acrylate, are preferable among those shown as an example.

The weight ratio of the (meth)acryl-based polymer (A) segment in the block copolymer or graft copolymer is preferably 50% to 95%, more preferably 60% to 85%, from the viewpoint of achievement of stable adhering strength and durability. If the weight ratio of the (meth)acryl-based polymer (A) segment is less than 50%, adhering strength easily decreases. If the weight ratio of the (meth)acryl-based polymer (A) segment is more than 95%, the ratio of the (meth)acryl-based polymer (B) segment is small, and therefore cohesive strength is reduced, thus being not preferable in terms of durability when used as a pressure-sensitive adhesive for an optical film.

As long as the (meth)acryl-based polymer (B) segment contains a (meth)acrylic acid alkyl ester as a main component of a monomer unit, and its glass transition temperature is 40° C. or more, the type of monomer units and the composition of components thereof are not particularly limited, but it is preferred that the (meth)acrylic acid alkyl ester constitutes 15% by weight or more, and further 20% by weight or more, of total monomer units in that the glass transition temperature is controlled.

Examples of the (meth)acrylic acid alkyl ester as a main monomer unit of the (meth)acryl-based polymer (B) segment include (meth)acrylic acid alkyl esters with the alkyl group having 1 to 18 carbon atoms. Specific examples thereof include (meth)acrylic acid alkyl esters such as methyl (meth)acrylate, ethyl (meth)acrylate, propyl (meth)acrylate, n-butyl (meth)acrylate, t-butyl (meth)acrylate, n-hexyl (meth)acrylate, cyclohexyl (meth)acrylate, 2-ethylhexyl (meth)acrylate, n-octyl (meth)acrylate, lauryl (meth)acrylate, tridecyl (meth)acrylate, stearyl (meth)acrylate and isobornyl (meth)acrylate. They may be used alone or in combination of two or more thereof. The (meth)acryl-based polymer (B) segment is preferably a methacryl-based polymer segment having a methacrylic acid alkyl ester as a main monomer unit. As the main monomer unit, acrylic acid alkyl esters with the alkyl group having 1 to 2 carbon atoms, such as methyl methacrylate and ethyl methacrylate, are preferable among those shown as an example.

The weight ratio of the (meth)acryl-based polymer (B) segment in the block copolymer or graft copolymer is a ratio of constituents other than the (meth)acryl-based polymer (A) segment.

The (meth)acryl-based polymer (A) segment and (meth)acryl-based polymer (B) segment may contain other monomer units as long as the amount thereof is 10% by weight or less of the total monomer units in each segment. Examples of the aforementioned other monomer units include (meth)acrylic acid esters having a functional group, such as methoxyethyl (meth)acrylate, ethoxyethyl (meth)acrylate, diethylaminoethyl (meth)acrylate, 2-hydroxyethyl (meth)acrylate, 2-aminoethyl (meth)acrylate, glycidyl (meth)acrylate and tetrahydrofurfuryl (meth)acrylate; vinyl-based monomers having a carboxyl group, such as (meth)acrylic acid, crotonic acid, maleic acid, maleic anhydride, fumaric acid and (meth)acrylamide; aromatic vinyl-based monomers such as styrene, α-methylstyrene and p-methylstyrene; conjugated diene-based monomers such as butadiene and isoprene; olefin-based monomers such as ethylene and propylene; and lactone-based monomers such as ∈-caprolactone and valerolactone. They may be listed alone, or in combination two or more thereof.

The method for producing the block copolymer or graft copolymer is not particularly limited as long as a block copolymer or graft copolymer having the (meth)acryl-based polymer (A) segment and (meth)acryl-based polymer (B) segment is obtained, and a method based on a publicly known method may be employed. Generally, a method of carrying out living polymerization of a monomer as a constituent unit is employed as a method for obtaining a block copolymer having a narrow molecular weight distribution. Examples of the method of living polymerization as described above include a method in which polymerization is carried out using an organic rare earth metal complex as a polymerization initiator (JP-A-6-93060), a method in which anionic polymerization is carried out in the presence of a mineral acid salt such as a salt of an alkali metal or alkali earth metal using an organic alkali metal compound as a polymerization initiator (JP-A-7-25859), a method in which anionic polymerization is carried out in the presence of an organic aluminum compound using an organic alkali metal compound as a polymerization initiator (JP-A-11-335432), and an atom transfer radical polymerization method (ATRP) (Macromol. Chem. Phys. 201, pages 1108-1114 (2000)). As a method for obtaining a graft copolymer, mention is made of the method described in Japanese Patent No. 4228026 specification or the like.

In the case of production methods based on the anionic polymerization method using an organic aluminum compound as a co-catalyst, among those described above, inactivation in the course of polymerization is few, contamination with a homopolymer as an inactivated component is therefore small, and as a result, the transparency of the pressure-sensitive adhesive obtained is high. Further, since the polymerization conversion ratio of the monomer is high, the amount of residual monomers in the product is small, so that generation of air bubbles after bonding can be suppressed when used as a pressure-sensitive adhesive for an optical film. Further, the molecular structure of the (meth)acryl-based polymer (B) segment block becomes highly syndiotactic, thus bringing about an effect of improving durability when used for a pressure-sensitive adhesive for an optical film. In addition, there is the advantage that living polymerization can be carried out under relatively mild temperature conditions, and therefore environmental burdens (principally electric power that acts on a refrigerator for controlling the polymerization temperature) can be kept low in the case of industrial production.

As the method of anionic polymerization in the presence of an organic aluminum compound, for example, a method can be employed in which a (meth)acrylic acid ester is polymerized in the presence of an organic lithium compound and an organic aluminum compound represented by the following general formula (1):

AlR¹R²R³ (1)

(wherein R¹, R² and R³ each independently represent an alkyl group which may have a substituent, a cycloalkyl group which may have a substituent, an aryl group which may have a substituent, an aralkyl group which may have a substituent, an alkoxyl group which may have a substituent, an aryloxy group which may have a substituent, or a N, N-disubstituted amino group, or R¹ represents any one of the groups described above, and R² and R³ together represent an arylenedioxy group which may have a substituent) using further an ether such as dimethyl ether, dimethoxyethane, diethoxyethane or 12-crown-4; and a nitrogen-containing compound such as triethylamine, N,N,N′,N′-tetramethylethylenediamine, N,N,N′,N″,N″-pentamethyldiethylenetriamine, 1,1,4,7,10,10-hexamethyltriethylenetetramine, pyridine or 2,2′-dipyridyl in the reaction system as necessary.

Examples of the organic lithium compound described above include alkyl lithiums and alkyl dilithiums such as methyl lithium, ethyl lithium, n-propyl lithium, isopropyl lithium, n-butyl lithium, sec-butyl lithium, isobutyl lithium, tert-butyl lithium, n-pentyl lithium, n-hexyl lithium, tetramethylene dilithium, pentamethylene dilithium and hexamethylenedilithium; aryl lithiums and aryl dilithiums such as phenyl lithium, m-tolyl lithium, p-tolyl lithium, xylyl lithium and lithium naphthalene; aralkyl lithiums and aralkyl dilithiums such as benzyl lithium, diphenylmethyl lithium, trityl lithium, 1,1-diphenyl-3-methylpentyl lithium, α-methylstyryl lithium, and dilithium produced by reaction of diisopropenylbenzene with butyl lithium; lithium amides such as lithium dimethylamide, lithium diethylamide and lithium diisopropylamide; lithium alkoxides such as methoxy lithium, ethoxy lithium, n-propoxy lithium, isopropoxy lithium, n-butoxy lithium, sec-butoxy lithium, tert-butoxy lithium, pentyloxy lithium, hexyloxy lithium, heptyloxy lithium, octyloxy lithium, phenoxy lithium, 4-methylphenoxy lithium, benzyloxy lithium, and 4-methylbenzyloxy lithium. They may be used alone, or used in combination of two or more thereof.

Examples of the organic aluminum compound represented by the general formula described above include trialkyl aluminums such as trimethyl aluminum, triethyl aluminum, tri-n-butyl aluminum, tri-s-butyl aluminum, tri-t-butyl aluminum, triisobutyl aluminum, tri-n-hexyl aluminum, tri-n-octyl aluminum, tri-2-ethylhexyl aluminum and triphenyl aluminum; dialkylphenoxy aluminums such as dimethyl(2,6-di-tert-butyl-4-methylphenoxy)aluminum, dimethyl(2,6-di-tert-butylphenoxy)aluminum, diethyl(2,6-di-tert-butyl-4-methylphenoxy)aluminum, diethyl(2,6-di-tert-butylphenoxy)aluminum, diisobutyl(2,6-di-tert-butyl-4-methylphenoxy)aluminum, diisobutyl(2,6-di-tert-butylphenoxy)aluminum, di-n-octyl(2,6-di-tert-butyl-4-methylphenoxy)aluminum and di-n-octyl(2,6-di-tert-butylphenoxy)aluminum; alkyldiphenoxy aluminums such as methylbis(2,6-di-tert-butyl-4-methylphenoxy)aluminum, methylbis(2,6-di-tert-butylphenoxy)aluminum, ethyl[2,2′-methylenebis(4-methyl-6-tert-butylphenoxy)]aluminum, ethylbis(2,6-di-tert-butyl-4-methylphenoxy)aluminum, ethylbis(2,6-di-tert-butylphenoxy)aluminum, ethyl[2,2′-methylenebis(4-methyl-6-tert-butylphenoxy)]aluminum, isobutylbis(2,6-di-tert-butyl-4-methylphenoxy)aluminum, isobutylbis(2,6-di-tert-butylphenoxy)aluminum, isobutyl[2,2′-methylenebis(4-methyl-6-tert-butylphenoxy)]aluminum, n-octylbis(2,6-di-tert-butyl-4-methylphenoxy)aluminum, n-octylbis(2,6-di-tert-butylphenoxy)aluminum and n-octyl[2,2′-methylenebis(4-methyl-6-tert-butylphenoxy)]aluminum; alkoxydiphenoxy aluminums such as methoxybis(2,6-di-tert-butyl-4-methylphenoxy)aluminum, methoxybis(2,6-di-tert-butylphenoxy)aluminum, methoxy[2,2′-methylenebis(4-methyl-6-tert-butylphenoxy)]aluminum, ethoxybis(2,6-di-tert-butyl-4-methylphenoxy)aluminum, ethoxybis(2,6-di-tert-butylphenoxy)aluminum, ethoxy[2,2′-methylenebis(4-methyl-6-tert-butylphenoxy)]aluminum, isopropoxybis(2,6-di-tert-butyl-4-methylphenoxy)aluminum, isopropoxybis(2,6-di-tert-butylphenoxy)aluminum, isopropoxy[2,2′-methylenebis(4-methyl-6-tert-butylphenoxy)]aluminum, tert-butoxybis(2,6-di-tert-butyl-4-methylphenoxy)aluminum, tert-butoxybis(2,6-di-tert-butylphenoxy)aluminum and tert-butoxy[2,2′-methylenebis(4-methyl-6-tert-butylphenoxy)]aluminum; and triphenoxy aluminums such as tris(2,6-di-tert-butyl-4-methylphenoxy)aluminum and tris(2,6-diphenylphenoxy)aluminum. Among these organic aluminum compounds, for example, isobutylbis(2,6-di-tert-butyl-4-methylphenoxy)aluminum, isobutylbis(2,6-di-tert-butylphenoxy)aluminum and isobutyl[2,2′-methylenebis(4-methyl-6-tert-butylphenoxy)]aluminum are particularly preferable because handling is easy, and polymerization of an acrylic acid ester can be advanced under relatively mild temperature conditions without causing inactivation. They may be used alone, or used in combination of two or more thereof.

As the acryl-based pressure-sensitive adhesive, a pressure-sensitive adhesive formed by blending a crosslinking agent with a base polymer, the base polymer being an acryl-based polymer having a monomer unit of an alkyl (meth)acrylate as a main backbone, can be used. It is to be noted that the (meth)acrylate refers to an acrylate and/or a methacrylate, and has the same meaning as (meth) in the present invention.

The number of carbon atoms of the alkyl group of the alkyl (meth)acrylate, which forms the main backbone of the acryl-based polymer, is about 1 to 14, and specific examples of the alkyl (meth)acrylate may include methyl (meth)acrylate, ethyl (meth)acrylate, propyl (meth)acrylate, isopropyl (meth)acrylate, n-butyl (meth)acrylate, isobutyl (meth)acrylate, pentyl (meth)acrylate, hexyl (meth)acrylate, 2-ethylhexyl (meth)acrylate, octyl (meth)acrylate, isooctyl (meth)acrylate, nonyl (meth)acrylate, isononyl (meth)acrylate, decyl (meth)acrylate, dodecyl (meth)acrylate and stearyl (meth)acrylate. They may be used alone, or in combination thereof. Among them, alkyl (meth)acrylates with the alkyl group having 1 to 9 carbon atoms are preferable.

One or more of various kinds of monomers can be introduced into the acryl-based polymer by copolymerization for the purpose of improving tackiness and heat resistance. Specific examples of the copolymerization monomer described above include carboxyl group-containing monomers, hydroxyl group-containing monomers, nitrogen-containing monomers (including heterocycle-containing monomers) and aromatic substance-containing monomers.

Examples of the carboxyl group-containing monomer include acrylic acid, methacrylic acid, carboxyethyl (meth)acrylate, carboxypentyl (meth)acrylate, itaconic acid, maleic acid, fumaric acid and crotonic acid. Among them, acrylic acid and methacrylic acid are preferable.

Examples of the hydroxyl group-containing monomer include 2-hydroxyethyl (meth)acrylate, 2-hydroxypropyl (meth)acrylate, 4-hydroxybutyl (meth)acrylate, 6-hydroxyhexyl (meth)acrylate, 8-hydroxyoctyl (meth)acrylate, 10-hydroxydecyl (meth)acrylate, 12-hydroxylauryl (meth)acrylate and (4-hydroxymethylcyclohexyl)-methyl acrylate.

Examples of the nitrogen-containing monomer include maleimide, N-cyclohexyl maleimide, N-phenyl maleimide; N-acryloyl morpholine; (N-substituted) amine-based monomers such as (meth)acrylamide, N,N-dimethyl (meth)acrylamide, N,N-diethyl (meth)acrylamide, N-hexyl (meth)acrylamide, N-methyl (meth)acrylamide, N-butyl (meth)acrylamide, N-butyl (meth)acrylamide, N-methylol (meth)acrylamide and N-methylolpropane (meth)acrylamide; alkyl-aminoalkyl (meth)acrylate-based monomers such as aminoethyl (meth)acrylate, aminopropyl (meth)acrylate, N,N-dimethylaminoethyl (meth)acrylate, t-butylaminoethyl (meth)acrylate and 3-(3-pyridinyl)propyl (meth)acrylate; alkoxyalkyl (meth)acrylate-based monomers such as methoxyethyl (meth)acrylate and ethoxyethyl (meth)acrylate; and also succinimide-based monomers such as N-(meth) acryloyloxymethylenesuccinimide, N-(meth)acryloyl-6-oxyhexamethylenesuccinimide, N-(meth)acryloyl-8-oxyoctamethylenesuccinimide and N-acryloylmorpholine as examples of monomers intended for modification.

Examples of the aromatic substance-containing monomer include benzyl (meth)acrylate, phenyl (meth)acrylate and phenoxyethyl (meth)acrylate.

Examples of the monomer include, in addition to the above-mentioned monomers, acid anhydride group-containing monomers such as maleic anhydride and itaconic anhydride; caprolactone adducts of acrylic acid; sulfonic acid group-containing monomers such as styrene sulfonic acid, allyl sulfonic acid, 2-(meth)acrylamide-2-methylpropanesulfonic acid, (meth)acrylamidepropanesulfonic acid, sulfopropyl (meth)acrylate and (meth)acryloyloxynaphthalenesulfonic acid; and phosphoric acid group-containing monomers such as 2-hydroxyethylacryloyl phosphate.

Further, vinyl-based monomers such as vinyl acetate, vinyl propionate, N-vinylpyrrolidone, methylvinylpyrrolidone, vinylpyridine, vinylpiperidone, vinylpyrimidine, vinylpiperazine, vinylpyrazine, vinylpyrrole, vinylimidazole, vinyloxazole, vinylmorpholine, N-vinylcarboxylic acid amides, styrene, α-methylstyrene and N-vinylcaprolactam; cyanoacrylate-based monomers such as acrylonitrile and methacrylonitrile; epoxy group-containing acryl-based monomers such as glycidyl (meth)acrylate; glycol-based acryl ester monomers such as polyethylene glycol (meth)acrylate, polypropylene glycol (meth)acrylate, methoxyethylene glycol (meth)acrylate, methoxy polypropylene glycol (meth)acrylate; acrylic acid ester-based monomers such as tetrahydrofurfuryl (meth)acrylate, fluorine (meth)acrylate, silicone (meth)acrylate and 2-methoxyethyl acrylate; and the like can be used.

Among them, hydroxyl group-containing monomers are suitably used because they have good reactivity with a crosslinking agent. Carboxyl group-containing monomers such as acrylic acid are preferably used in terms of tackiness and bond durability.

The ratio of the aforementioned copolymerization monomer in the acryl-based polymer is not particularly limited, but is 50% by weight or less in terms of a weight ratio. The ratio is preferably 0.1 to 10% by weight, more preferably 0.5 to 8% by weight, further preferably 1 to 6% by weight.

The average molecular weight of the acryl-based polymer is not particularly limited, but its weight average molecular weight is preferably about 300000 to 2500000. The acryl-based polymer can be produced by various kinds of publicly known methods, and for example, a radical polymerization method such as a bulk polymerization method, a solution polymerization method or suspension polymerization method can be appropriately selected. As a radical polymerization initiator, any one of those that are publicly known, such as azo-based and peroxide-based radical polymerization initiators, can be used. The reaction temperature is normally about 50 to 80° C., and the reaction time is 1 to 8 hours. Among the aforementioned production methods, the solution polymerization method is preferable, and ethyl acetate, toluene or the like is generally used as a solvent for the acryl-based polymer.

The crosslinking agent blended with the acryl-based polymer can improve adhesion with a transparent conductive film and durability, and can maintain reliability at a high temperature and the shape of the pressure-sensitive adhesive itself. As the crosslinking agent, an isocyanate-based, an epoxy-based, a peroxide-based, a metal chelate-based or an oxazoline-based crosslinking agent, etc. can be appropriately used. These crosslinking agents can be used alone, or in combination of two or more thereof.

For the isocyanate-based crosslinking agent, an isocyanate compound is used. Examples of the isocyanate compound include isocyanate monomers such as tolylene diisocyanate, chlorophenylene diisocyanate, hexamethylene diisocyanate, tetramethylene diisocyanate, isophorone diisocyanate, xylylene diisocyanate, diphenylmethane diisocyanate and hydrogenated diphenylmethane diisocyanate, and adduct-based isocyanate compounds obtained by adding the above-mentioned isocyanate monomers with trimethylolpropane or the like; isocyanurated products, burette type compounds, and urethane prepolymer type isocyanates obtained by subjecting a known polyether polyol, polyester polyol, acryl polyol, polybutadiene polyol, polyisoprene polyol or the like to an addition reaction.

The isocyanate-based crosslinking agents may be used alone, or used in mixture of two or more thereof, but for the overall content, the polyisocyanate compound crosslinking agent is contained preferably in an amount of 0.01 to 2 parts by weight, more preferably in an amount of 0.02 to 2 parts by weight, further preferably in an amount of 0.05 to 1.5 parts by weight, based on 100 parts by weight of the (meth)acryl-based polymer (A). The isocyanate-based crosslinking agent can be appropriately contained in consideration of cohesive strength and inhibition of peeling in a durability test.

As the peroxide-based crosslinking agent, various kinds of peroxides are used. Examples of the peroxide include di-(2-ethylhexyl)peroxydicarbonate, di(4-t-butylcyclohexyl)peroxydicarbonate, di-sec-butyl peroxydicarbonate, t-butyl peroxyneodecanoate, t-hexyl peroxypivalate, t-butyl peroxypivalate, dilauroyl peroxide, di-n-octanoyl peroxide, 1,1,3,3-tetramethylbutyl peroxyisobutyrate, 1,1,3,3-tetramethylbutylperoxy 2-ethylhexanoate, di-(4-methylbenzoyl)peroxide, dibenzoyl peroxide and t-butyl peroxyisobutyrate. Among them, particularly, di(4-t-butylcyclohexyl)peroxydicarbonate, dilauroyl peroxide and dibenzoyl peroxide, which are excellent in crosslinking reaction efficiency, are preferably used.

The peroxides may be used alone, or in mixture of two or more thereof, but for the overall content, the peroxide is contained in an amount of 0.01 to 2 parts by weight, preferably in an amount of 0.04 to 1.5 parts by weight, more preferably in an amount of 0.05 to 1 parts by weight, based on 100 parts by weight of the (meth)acryl-based polymer (A). The content is appropriately selected within this range for adjustment of processability, reworkability, crosslinking stability and the peeling property.

Further, the pressure-sensitive adhesive of the present invention may contain a silane coupling agent. By using the silane coupling agent, durability can be improved. As the silane coupling agent, a silane coupling agent having any appropriate functional group can be used. Specific examples of the functional group include a vinyl group, an epoxy group, an amino group, a mercapto group, a (meth)acryloxy, an acetoacetyl group, an isocyanate group, a styryl group, and a polysulfide group. Specific examples include vinyl group-containing silane coupling agents such as vinyltriethoxysilane, vinyltripropoxysilane, vinyltriisopropoxysilane and vinyltributoxysilane; epoxy group-containing silane coupling agents such as γ-glycidoxypropyltrimethoxysilane, γ-glycidoxypropyltriethoxysilane, 3-glycidoxypropylmethyldiethoxysilane and 2-(3,4-epoxycyclohexyl)ethyltrimethoxysilane; amino group-containing silane coupling agents such as γ-aminopropyltrimethoxysilane, N-β-(aminoethyl)-γ-aminopropylmethyldimethoxysilane, N-(2-aminoethyl)-3-aminopropylmethyldimethoxysilane, γ-triethoxysilyl-N-(1,3-dimethylbutylidene)propylamine and N-phenyl-γ-aminopropyltrimethoxysilane; mercapto group-containing silane coupling agents such as γ-mercaptopropylmethyldimethoxysilane; styryl group-containing silane coupling agents such as p-styryltrimethoxysilane; (meth)acryl group-containing silane coupling agents such as γ-acryloxypropyltrimethoxysilane and γ-methacryloxypropyltriethoxysilane; isocyanate group-containing silane coupling agents such as 3-isocyanatepropyltriethoxysilane; and polysulfide group-containing silane coupling agents such as bis(triethoxysilylpropyl)tetrasulfide.

The silane coupling agents may be used alone, or used in mixture of two or more thereof, but for the overall content, the silane coupling agent is contained preferably in an amount of 0.001 to 5 parts by weight, further preferably in an amount of 0.01 to 1 part by weight, still further preferably in an amount of 0.02 to 1 part by weight, still further preferably in an amount of 0.05 to 0.6 parts by weight based on 100 parts by weight of the acryl-based polymer.

For example, appropriate additives such as a filler formed of resins of a natural product or synthetic product, glass fibers, glass beads, a metal powder or other inorganic powders, a pigment, a colorant and an antioxidant can also be blended in the pressure-sensitive adhesive layer 3 as necessary. Also, transparent fine particles can be included to form the pressure-sensitive adhesive layer 3 provided with light diffusion characteristics.

As the transparent fine particles, one or more kinds of appropriate fine particles such as, for example, conductive inorganic fine particles of silica, calcium oxide, alumina, titania, zirconia, tin oxide, indium oxide, cadmium oxide, antimony oxide and the like, which have an average particle diameter of 0.5 to 20 μm and crosslinked or uncrosslinked organic fine particles formed of an appropriate polymer such as polymethyl methacrylate or polyurethane can be used.

The aforementioned pressure-sensitive adhesive layer 3 is normally used as a pressure-sensitive adhesive solution having a solid concentration of about 10 to 50% by weight, which is obtained by dissolving or dispersing a base polymer or a composition thereof in a solvent. As the aforementioned solvent, solvent appropriate to the type of the pressure-sensitive adhesive, such as an organic solvent including toluene or ethyl acetate, or water can be appropriately selected and used.

The thickness of the pressure-sensitive adhesive layer 3 is controlled so that the total thickness as a sum of the thickness of the pressure-sensitive adhesive layer 3 and the thickness of the film base 1 is 30 to 300 μm. The total thickness is preferably 20 to 280 μm, further preferably 20 to 170 μm, still further preferably 20 to 110 μm. By controlling the total thickness to fall within the aforementioned range, the degree of design freedom for a gap between electrodes is increased, so that a transparent conductive film suitable for a capacitive touch panel can be obtained with high productivity, in the case of use for an electrode substrate of a multi-touch type touch panel. The thickness of the pressure-sensitive adhesive layer 3 is, specifically, selected preferably from range of 10 to 170 μm, further preferably from a range of 10 to 110 μm, still further preferably from a range of 10 to 80 μm.

The pressure-sensitive adhesive layer 3 can be formed by applying a pressure-sensitive adhesive solution directly to the film base 1, and drying the applied solution. The pressure-sensitive adhesive solution is applied to a separator S, and dried to form the pressure-sensitive adhesive layer 3, and the pressure-sensitive adhesive layer 3 formed on the separator S can be laminated on the film base 1 as the pressure-sensitive adhesive layer 3 with the separator S by transferring the pressure-sensitive adhesive layer 3 to the film base 1.

When the pressure-sensitive adhesive layer 3 is transferred using the separator S, for example, a polyester film or the like is preferably used as such a separator S in which a migration prevention layer and/or a release layer are laminated on at least a surface of the polyester film that is bonded to the pressure-sensitive adhesive layer 3.

The total thickness of the separator S is preferably 30 μm or more, more preferably in a range of 60 to 100 μm. This is because deformation (impressions) of the pressure-sensitive adhesive layer 3 thought to be caused by contaminants and the like trapped between rolls is suppressed when the film is stored in the form of a roll after the pressure-sensitive adhesive layer 3 is formed.

The migration prevention layer can be formed of an appropriate material for preventing migration of migrant components in the polyester film, particularly low-molecular weight oligomer components of polyester. As the material for formation of the migration prevention layer, an inorganic or organic substance, or a composite material thereof can be used. The thickness of the migration prevention layer can be appropriately set within a range of 0.01 to 20 μm. The method for formation of a migration prevention layer is not particularly limited, and for example a coating method, a spraying method, a spin coating method, an in-line coating method or the like is used. A vacuum deposition method, a sputtering method, an ion plating method, a spray thermal decomposition method, a chemical plating method, an electroplating method or the like can also be used.

As the release layer, a release layer including an appropriate release agent such as a silicone-based release agent, a long chain alkyl-based release agent, a fluorine-based release agent or molybdenum sulfide can be formed. The thickness of the release layer can be appropriately set from the viewpoint of a mold release effect. Generally, the thickness is preferably 20 μm or less, more preferably in a range of 0.01 to 10 μm, especially preferably in a range of 0.1 to 5 μm from the viewpoint of handleability such as flexibility. The method for formation of the release layer is not particularly limited, and a method similar to the method for formation of the migration prevention layer can be employed.

In the aforementioned coating method, spraying method, spin coating method and in-line coating method, an ionizing radiation curable resin such as an acryl-based resin, a urethane-based resin, a melamine-based resin or an epoxy-based resin, or a mixture of the resin with aluminum oxide, silicon dioxide, mica or the like can be used. When a vacuum deposition method, a sputtering method, an ion plating method, a spray thermal decomposition method, a chemical plating method or an electroplating method is used, a metal oxide including gold, silver, platinum, palladium, copper, aluminium, nickel, chromium, titanium, iron, cobalt or tin, or an alloy thereof, or other metal compounds including steel iodide or the like can be used.

When the pressure-sensitive adhesive layer 3 is laminated on the film base 1, a surface of the film base 1, on which the pressure-sensitive adhesive layer 3 is laminated, can be provided with an oligomer prevention layer G. As the material for forming the oligomer prevention layer G, any appropriate material capable of forming a transparent film is used, and the material may be an inorganic substance, an organic substance or a composite material thereof. The thickness of the oligomer prevention layer is preferably 0.01 to 20 μm. For formation of the oligomer prevention layer 5, a coating method using a coater, a spraying method, a spin coating method, an in-line coating method or the like is often used, but a method such as a vacuum deposition method, a sputtering method, an ion plating method, a spray thermal decomposition method, a chemical plating method or an electroplating method may be used. In the coating method, a resin component such as a polyvinyl alcohol-based resin, an acryl-based resin, a urethane-based resin, a melamine-based resin, an UV curable resin or an epoxy-based resin, or a mixture of the above-mentioned resin with inorganic particles of alumina, silica, mica or the like may be used. Alternatively, the base component may be made to have a function as a prevention layer 5 by co-extrusion of a polymer substrate in two or more layers. In a method such as a vacuum deposition method, a sputtering method, an ion plating method, a spray thermal decomposition method, a chemical plating method or an electroplating method, a metal including gold, silver, platinum, palladium, copper, aluminum, nickel, chromium, titanium, iron, cobalt or tin, or an alloy thereof, or a metal oxide including indium oxide, tin oxide, titanium oxide, cadmium oxide or a mixture thereof, or other metal compounds including steel iodide or the like can be used.

Among the materials for formation of the oligomer prevention layer G as shown above as an example, the polyvinyl alcohol-based resin is excellent in oligomer prevention function, and particularly suitable in applications of the present invention. The polyvinyl alcohol-based resin has a polyvinyl alcohol as a main component, and normally the content of the polyvinyl alcohol is preferably in a range of 30 to 100% by weight. A satisfactory oligomer deposition preventing effect is achieved when the content of the polyvinyl alcohol is 30% by weight or more. Examples of the resin that can be mixed together with the polyvinyl alcohol include aqueous resins such as polyester and polyurethane. The polymerization degree of the polyvinyl alcohol is not particularly limited, but normally a polyvinyl alcohol having a polymerization degree of 300 to 4000 is suitable in terms of applications. The saponification degree of the polyvinyl alcohol is not particularly limited, but normally a polyvinyl alcohol having a saponification degree of 70 mol % or more, and furthermore 99.9 mol % or more is suitable. The polyvinyl alcohol-based resin can be used in combination with a crosslinking agent. Specific examples of the crosslinking agent include various kinds of methylolated or alkylolated urea-based, melamine-based, guanamine-based, acrylamide-based and polyamide-based compounds, epoxy compounds, aziridine compounds, block isocyanates, silane coupling agents, titanium coupling agents and zirco-alminate coupling agents. These crosslinking components may be bound to a binder polymer beforehand. Inorganic particles may be contained for the purpose of improving adherence and slippage, and specific examples thereof include silica, alumina, kaolin, calcium carbonate, titanium oxide and a barium salt. An antifoaming agent, a coatability improving agent, a thickener, an organic lubricant, organic polymer particles, an antioxidant, an ultraviolet absorber, a foaming agent, a dye and the like may be contained as necessary.

As described previously, control is performed so that the total thickness of the film base 1 and the pressure-sensitive adhesive layer 3 is 30 to 300 μm, but when the oligomer prevention layer G is provided between the film base 1 and the pressure-sensitive adhesive layer 3, it is preferred to perform control so that the total thickness of the film base 1 and the pressure-sensitive adhesive layer 3, including a layer formed by the oligomer prevention layer G, falls within the aforementioned range.

The method for producing the transparent conductive film with a pressure-sensitive adhesive layer according to the present invention is not particularly limited as long as it is a method by which a transparent conductive film having the aforementioned structure can be obtained. For example, the transparent conductive film with a pressure-sensitive adhesive layer according to the present invention can be obtained by carrying out a step A of providing a laminated body which has a transparent conductive layer laminated on one surface of a film base 1 having a thickness of 10 to 110 μm and which has on the other surface of the film base a pressure sensitive adhesive layer which satisfies the predetermined storage modulus and the thickness of which is controlled so that the total thickness of the film base and the pressure-sensitive adhesive layer is 30 to 300 μm (a transparent conductive film with a pressure-sensitive adhesive layer in which the transparent conductive layer is not patterned), thereby preparing the laminated body, and then carrying out a step B of patterning the transparent conductive layer in the laminated body.

In the step A of providing the laminated body, normally the transparent conductive layer 2 (including the undercoat layer 4 in some cases) is formed on one surface of the film base 1 to produce a transparent conductive film, and then the pressure-sensitive adhesive layer 3 is laminated on the other surface of the transparent conductive film. The pressure-sensitive adhesive layer 3 may be formed directly on the film base 1 as described previously, or the pressure sensitive adhesive layer 3 may be provided on the separator S, and then bonded to the film base 1. The latter method is more advantageous in terms of productivity because the pressure-sensitive adhesive layer 3 can be continuously formed with the film base 1 formed into a roll.

In the patterning step B, patterning can be performed by etching the transparent conductive layer 2. In etching, the transparent conductive layer 2 is covered with a mask for forming a pattern, and the transparent conductive layer 2 is etched with an etchant.

Since for the transparent conductive layer 2, indium oxide containing tin oxide or tin oxide containing antimony is suitably used, an acid is suitably used as an etchant. Examples of the acid include inorganic acids such as hydrogen chloride, hydrogen bromide, sulfuric acid, nitric acid and phosphoric acid, organic acids such as acetic acid, mixtures thereof, and aqueous solutions thereof.

When the undercoat layer 4 is composed of at least two layers, only the transparent conductive layer 2 can be etched to be patterned, or after etching the transparent conductive layer 2 with an acid to be patterned, at least the undercoat layer at the largest distance from the film base 1 can be etched to be patterned like the transparent conductive layer 2. Preferably, the transparent conductive layer 2 excluding the first undercoat layer from the film base 1 can be etched to be patterned like the transparent conductive layer 2.

In etching of the undercoat layer 4, the undercoat layer 4 is covered with a mask for forming a pattern similar to that obtained by etching the transparent conductive layer 2, and the undercoat layer 4 is etched with an etchant. Since for the undercoat layer above the second layer, an inorganic substance such as SiO₂ is suitably used as described previously, an alkali is suitably used as an etchant. Examples of the alkali include aqueous solutions of sodium hydroxide, potassium hydroxide, ammonia, tetramethyl ammonium hydroxide and the like, and mixtures thereof. It is preferred that the first transparent conductive layer is formed of an organic substance that is not etched with an acid or an alkali.

When the patterned transparent conductive layer 2 is provided on the film base with the undercoat layer 4 of two layers interposed therebetween, in the patterned part, the refractive index (n) and thickness (d) of each layer and the sum of the optical thickness (n×d) of the aforementioned each layer can be as follows. Consequently, a difference in reflectance between the patterned part and the non-patterned part can be designed to be small.

The first undercoat layer 41 from the film base 1 can have a refractive index (n) of 1.5 to 1.7, and the refractive index (n) is preferably 1.5 to 1.65, more preferably 1.5 to 1.6. The thickness (d) is preferably 100 to 220 nm, further preferably 120 to 215 nm, still further preferably 130 to 210 nm.

The second undercoat layer 42 from the film base 1 can have a refractive index (n) of 1.4 to 1.5, and the refractive index (n) is preferably 1.41 to 1.49, more preferably 1.42 to 1.48. The thickness (d) is preferably 20 to 80 nm, further preferably 20 to 70 nm, still further preferably 20 to 60 nm.

The transparent conductive layer 2 can have a refractive index (n) of 1.9 to 2.1, and the refractive index (n) is preferably 1.9 to 2.05, more preferably 1.9 to 2.0. The thickness (d) is preferably 15 to 30 nm, further preferably 15 to 28 nm, still further preferably 15 to 25 nm.

The sum of the optical thickness (n×d) of the aforementioned each layer (the first undercoat layer 41, the second undercoat layer 42 and the transparent conductive layer 2) can be 208 to 554 nm, preferably 230 to 500 nm, more preferably 250 to 450 nm.

A difference (Δnd) between the sum of the optical thicknesses of the patterned parts and the optical thickness of the undercoat layer of the non-patterned part can be 40 to 130 nm. The difference (Δnd) in optical thickness is preferably 40 to 120 nm, more preferably 40 to 110 nm.

Further, the transparent conductive film with a pressure-sensitive adhesive layer according to the present invention can be subjected to a step C of heating the laminated body provided in the step A at 60 to 200° C. to crystallize the transparent conductive layer 2 in the laminated body. By heating in the crystallization step C, the transparent conductive layer 2 is crystallized. Since the transparent conductive film with a pressure-sensitive adhesive layer according to the present invention has the pressure-sensitive adhesive layer 3 having the above-described predetermined storage modulus laminated thereon, undulation of the film can be kept small even when the film is treated by heating.

The heating temperature in crystallization is normally about 60 to 200° C., preferably 100 to 150° C. The heating time is 5 to 250 minutes. From such a viewpoint, it is preferred that the film base 1 has a heat resistance of 100° C. or higher, further preferably 150° C. or higher because the film base is treated by heating as described above.

When the transparent conductive layer 2 is patterned by the patterning step B, undulation of the film becomes large, so that deterioration of appearance due to level differences of the transparent conductive layer tends to be noticeable. Thus, it is preferred that the crystallization step C is carried out after the laminated body provided in the step A is subjected to the patterning step B. In addition, since etching may become difficult when the transparent conductive layer 2 is crystallized, it is preferred that the crystallization step C is carried out after the transparent conductive layer 2 is patterned by the patterning step B. Further, when the undercoat layer 4 is etched, it is preferred that the crystallization step C is carried out after etching of the undercoat layer 4.

The transparent conductive film with a pressure-sensitive adhesive layer according to the present invention can be used for an electrode substrate of an input device of a capacitive touch panel. For the capacitive touch panel, a multi-touch type can be employed, and the transparent conductive film with a pressure-sensitive adhesive layer according to the present invention can be used as a part of the electrode substrate. FIGS. 6 to 8 each are a sectional view of the input device of the touch panel when the transparent conductive film with a pressure-sensitive adhesive layer 11 shown in FIG. 1 is used for the electrode substrate.

FIG. 6 relates to a face-down type, and shows a case where two sheets of the transparent conductive film with a pressure-sensitive adhesive layer 11 shown in FIG. 1 are used in such a manner as to be laminated together with the transparent conductive layer 2 facing downward with respect to a window W. The pressure-sensitive adhesive layer 3 of the transparent conductive film with a pressure-sensitive adhesive layer 11 on the upper side is bonded to the window W. On the other hand, the transparent conductive film with a pressure-sensitive adhesive layer 11 on the lower side is bonded to a film base 1′ with a pressure-sensitive adhesive layer 3′ interposed therebetween. The lower surface of the film base 1′ is provided with a functional layer F.

FIG. 7 relates to a face-up type, and shows a case where one sheet of the transparent conductive film with a pressure-sensitive adhesive layer 11 shown in FIG. 1 is used with the transparent conductive layer 2 facing upward with respect to the window W. The transparent conductive layer 2 of the transparent conductive film with a pressure-sensitive adhesive layer 11 is bonded to the window W with the pressure-sensitive adhesive layer 3′ interposed therebetween. On the other hand, another transparent conductive film (having the patterned transparent conductive layer 2′ provided on the film base 1′) is bonded, on the side of the transparent conductive layer 2′, to the pressure-sensitive adhesive layer 3 of the transparent conductive film with a pressure-sensitive adhesive layer 11. The lower surface of the film base 1′ is provided with a functional layer F.

FIG. 8 relates to a double-face type. In FIG. 8, one sheet of the transparent conductive film with a pressure-sensitive adhesive layer 11 shown in FIG. 1 is used with the transparent conductive layer 2 facing upward with respect to the window W, and the transparent conductive layer 2 of the transparent conductive film with a pressure-sensitive adhesive layer 11 is bonded to the window W with the pressure-sensitive adhesive layer 3′ interposed therebetween. On the other hand, another transparent conductive film (having the patterned transparent conductive layer 2′ provided on the film base 1″) is bonded, on the side of the film base 1″, to the pressure-sensitive adhesive layer 3 of the transparent conductive film with a pressure-sensitive adhesive layer 11. Further, the film base 1″ is bonded thereto with a pressure-sensitive adhesive layer 3″ interposed therebetween. The lower surface of the film base 1″ is provided with a functional layer F.

FIGS. 6 to 8 illustrate a case where the transparent conductive film with a pressure-sensitive adhesive layer 11 shown in FIG. 1 is used, but transparent conductive films 12 to 15 with a pressure-sensitive adhesive layer shown in FIGS. 2 to 5, and other forms of transparent conductive films can be used as well. FIGS. 6 to 8 show one example of multi-touch type, and the number of laminated layers, the combination and order of laminated layers, and the like for the transparent conductive film with a pressure-sensitive adhesive layer can be appropriately combined.

As a material that is used for film bases 1′ and 1″ shown in FIGS. 6 to 8, a material shown as an example for the film base 1 can be used. The thickness of film bases 1′ and 1″ is not particularly limited, but normally, is preferably 10 to 110 μm.

The material of pressure-sensitive adhesive layers 3′ and 3″ is not particularly limited, but a material shown as an example for the pressure-sensitive adhesive layer 3 can be used, and a material that has been used for bonding of the transparent conductive film in the touch panel can also be used. The thickness of the pressure-sensitive adhesive layers 3′ and 3″ is not particularly limited but normally, is preferably 10 to 170 μm.

For the window W, a glass plate, an acryl plate, a polycarbonate plate or the like is normally used.

As the functional layer F, an antiglare treatment layer or an antireflection layer can be provided.

The constituent material of the antiglare treatment layer is not particularly limited, and for example an ionizing radiation-curable resin, a thermosetting resin, a thermoplastic resin or the like can be used. The thickness of the antiglare treatment layer is preferably 0.1 to 30 μm.

For the antireflection layer, titanium oxide, zirconium oxide, silicon oxide, magnesium fluoride or the like is used. For exhibiting the antireflection function more significantly, a laminated body of a titanium oxide layer and a silicon oxide layer is preferably used.

### EXAMPLES

The present invention will be described in detail below with reference to Examples, but the present invention is not limited to Examples below as long as the spirit of the present invention is maintained. In each Example, “part(s)” and “%” are both on the weight basis unless otherwise specified.

<Measurement of Weight Average Molecular Weight (Mw) by Gel Permeation Chromatography (GPC)>

Apparatus: Gel Permeation Chromatograph (HLC-8020) manufactured by TOSOH CORPORATION
Column: tandemly coupled TSKgel GMHXL, G4000HXL and G5000HXL manufactured by TOSOH CORPORATION
Eluent: tetrahydrofuran
Eluent flow rate: 1.0 ml/minute
Column temperature: 40° C.
Detection method: differential refractive index (RI)
Calibration curve: created by use of standard polystyrene

<Measurement of Content of Each Copolymerization Component in Copolymer by Proton Nuclear Magnetic Resonance (¹H-NMR) Spectrometry>

Apparatus: nuclear magnetic resonance apparatus (JNM-LA400) manufactured by JEOL Ltd.
Solvent: heavy chloroform

In the ¹H-NMR spectrum, signals at around 3.6 ppm and 4.0 ppm were attributed, respectively, to an ester group of a methyl methacrylate unit (—O—CH₃) and an ester group of a n-butyl acrylate unit (—O—CH₂—CH₂—CH₂—CH₃), and from the ratio of their integrated values, the content of a copolymerization component was determined.

<Refractive Index>

Using an Abbe's refractometer manufactured by ATAGO CO., LTD, the refractive index of each layer was measured in accordance with the defined measurement method shown in the refractometer with measurement light made incident to various measurement surfaces.

<Thickness of Each Layer>

For layers having a thickness of 1 μm or more, such as a film base, a transparent substrate, a hard coat layer and a pressure-sensitive adhesive layer, measurements were performed using a microgage-type thickness meter manufactured by Mitutoyo Corporation. In the case of layers for which it was difficult to measure the thickness directly, such as the hard coat layer and the pressure-sensitive adhesive layer, the thickness of each layer was calculated by measuring the total thickness of the base provided with each layer and subtracting therefrom the thickness of the base.

The thickness of each of a first undercoat layer, a second undercoat layer, an ITO film and the like was calculated on the basis of a waveform from an interference spectrum using MCPD 2000 (product name), an instantaneous multi photometric system, manufactured by Otsuka Electronics Co., Ltd.

<Surface Resistance of Undercoat Layer>

The surface electric resistance (Ω/□) of the undercoat layer was measured using a surface high resistance meter manufactured by Mitsubishi Chemical Corporation in accordance with a double ring method conforming to JIS K 6911 (1995).

### Example 1

### Preparation of Polymer Forming Pressure-Sensitive Adhesive Layer

A three-way cock was attached to a 2 L three-necked flask, the interior of the flask was purged with nitrogen, 60.0 g of a toluene solution containing 868 g of toluene, 43.4 g of 1,2-dimethoxyethane and 40.2 mmol of isobutylbis(2,6-di-t-butyl-4-methylphenoxy) aluminum was then added at room temperature, and 3.68 g of a mixed solution of cyclohexane and n-hexane containing 6.37 mmol of sec-butyl lithium was further added. Subsequently, 51.5 g of methyl methacrylate (MMA) was added thereto, and the resulting mixture was stirred at room temperature for 60 minutes. Subsequently, the polymerization liquid was cooled so as to have an internal temperature of −30° C., and 240 g of n-butyl acrylate (nBA) was added dropwise over 2 hours. Next, 51.5 g of methyl methacrylate was added, the resulting mixture was stirred at room temperature overnight, and then 3.50 g of methanol was added to stop the polymerization reaction. The resulting reaction liquid was poured into methanol, and a precipitate was collected by filtration. The collected precipitate was dried to thereby obtain 340 g of a block copolymer 1.

The results of the ¹H-NMR measurement and the GPC measurement showed that the triblock copolymer 1 was a triblock copolymer of PMMA-PnBA-PMMA, and had a weight average molecular weight (Mw) of 7.9×10⁴, a number average molecular weight (Mn) of 6.2×10⁴ and a molecular weight distribution (Mw/Mn) of 1.27. Here, PMMA-PnBA-PMMA represents polymethyl methacrylate-poly(n-butyl acrylate)-polymethyl methacrylate. The weight ratio of monomer units of the triblock copolymer 1 was nBA/MMA=70/30.

(Formation of Pressure-Sensitive Adhesive Layer)

A pressure-sensitive adhesive solution having a solid concentration of 30% was prepared by dissolving the block copolymer 1 in toluene, and applied onto a separator formed of a release-treated polyester film (thickness of 38 μm) by a reverse coating method so that a dried pressure-sensitive adhesive layer had a thickness of 25 μm, and the applied solution was heated at 90° C. for 3 minutes to volatilize the solvent, thereby obtaining the pressure-sensitive adhesive layer.

(Formation of Undercoat Layer)

A first undercoat layer having a thickness of 185 nm was formed on one surface of a film base formed of a polyethylene terephthalate film (hereinafter, also referred to as a PET film) having a thickness of 25 μm using a thermosetting resin including a melamine resin, an alkyd resin and an organic silane condensate at a weight ratio of 2:2:1 (optical refractive index n=1.54). Then, a silica sol (product name “COLCOAT P” manufactured by COLCOAT CO., Ltd) was diluted with ethanol so as to have a solid concentration of 2%, applied onto the first undercoat layer by a silica coating method, then dried at 150° C. for 2 minutes, and cured to form a second undercoat layer having a thickness of 33 nm (SiO₂ film, optical refractive index: 1.46). Surface resistances after formation of the first and second undercoat layers were both 1×10¹²Ω/□ or more.

(Formation of Transparent Conductive Layer)

Next, an ITO film, as a transparent conductive layer, having a thickness of 22 nm (optical refractive index: 2.00) was formed on the second undercoat layer by a reactive sputtering method using a sintered body material composed of 97% by weight of indium oxide and 3% by weight of tin oxide in an atmosphere at 0.4 Pa including 98% of argon gas and 2% of oxygen gas.

<Preparation of Transparent Conductive Film with a Pressure-Sensitive Adhesive Layer>

Then, the pressure-sensitive adhesive layer formed on the separator as described above was bonded to a surface opposite to the ITO film forming surface to prepare a transparent conductive film with a pressure-sensitive adhesive layer.

(Patterning by Etching of ITO Film)

A photoresist patterned in a stripe form was applied to the transparent conductive layer of the transparent conductive film with a pressure-sensitive adhesive layer, and dried and cured, and thereafter the film was immersed in 5% hydrochloric acid (aqueous hydrogen chloride solution) at 25° C. for 1 minute to etch the ITO film.

(Patterning of Second Undercoat Layer by Etching)

After the ITO film was etched, the film, on which the photoresist was laminated, was subsequently immersed in a 2% aqueous sodium hydroxide solution at 45° C. for 3 minutes to etch the second undercoat layer, and thereafter the photoresist was removed.

(Crystallization of Transparent Conductive Layer)

After the second undercoat layer was etched, a heating treatment was carried out at 140° C. for 90 minutes to crystallize the ITO film.

### Examples 2 to 4

A transparent conductive film with a pressure-sensitive adhesive layer was prepared, and subsequent patterning and crystallization were performed in the same manner as in Example 1 except that a PET film having the thickness shown in Table 1 was used in place of the PET film having a thickness of 25 μm as a film base in Example 1.

### Example 5

A transparent conductive film with a pressure-sensitive adhesive layer was prepared, and subsequent patterning and crystallization were performed in the same manner as in Example 1 except that a PET film having a thickness of 75 μm was used in place of the PET film having a thickness of 25 μm as a film base, and the thickness of the pressure-sensitive adhesive layer was changed from 25 μm to 150 μm in Example 1.

### Example 6

### Preparation of Acryl-Based Polymer Solution

To a reaction vessel equipped with a cooling pipe, a nitrogen inlet, a thermometer and a stirrer, 100 parts of butyl acrylate, 5 parts of acrylic acid, 0.075 parts of 2-hydroxyethyl acrylate and 0.2 parts of 2,2′-azobisisobutyronitrile were added together with ethyl acetate, the resulting mixture was reacted at 55° C. for 10 hours under a nitrogen gas flow, and ethyl acetate was then added to the reaction liquid to obtain a solution (solid concentration: 30%) containing an acryl-based polymer having a weight average molecular weight of 2200000 (hereinafter, also referred to as “an acryl-based polymer solution (I)”).

(Preparation of Pressure-Sensitive Adhesive)

Uniformly mixed and stirred were 0.2 parts of dibenzoyl peroxide (product name “NYPER BMT” manufactured by NOF CORPORATION), 0.2 parts of diglycidyl aminomethyl cyclohexane as an epoxy-based crosslinking agent (product name “TETRAD C” manufactured by Mitsubishi Gas Chemical Company, Inc.), 0.1 parts of an adduct body of trimethylolpropane/tolylenediisocyanate as an isocyanate-based crosslinking agent (product name “CORONATEL” manufactured by Nippon Polyurethane Industry Co., Ltd.) and 0.075 parts of a silane coupling agent (KBM 403 manufactured by Shin-Etsu Chemical Co., Ltd.) with respect to 100 parts by solid content of the acryl-based polymer solution (I) to prepare an acryl-based pressure-sensitive adhesive solution (solid content: 10.9% by weight).

(Formation of Pressure-Sensitive Adhesive Layer)

The acryl-based pressure-sensitive adhesive was applied onto a separator formed of a release-treated polyester film (thickness of 38 μm) by a reverse coating method so that a dried pressure-sensitive adhesive layer had a thickness of 25 μm, and the applied adhesive was heated at 155° C. for 3 minutes to volatilize the solvent, thereby obtaining the pressure-sensitive adhesive layer.

<Preparation of Transparent Conductive Film with a Pressure-Sensitive Adhesive Layer, Etc.>

A transparent conductive film with a pressure-sensitive adhesive layer was prepared, and subsequent patterning and crystallization were performed in the same manner as in Example 1 except that the pressure-sensitive adhesive layer formed as described above was used as a pressure-sensitive adhesive layer in Example 1.

### Example 7

### Preparation of Polymer Forming Pressure-Sensitive Adhesive Layer

A triblock copolymer 2 of PMMA-PnBA-PMMA was obtained in the same manner as in Example 1 except that the weight ratio of monomer units was changed to nBA/MMA=60/40. The ratios of PMMAs at both sides are the same. The weight average molecular weight (Mw), number average molecular weight (Mn) and molecular weight distribution (Mw/Mn) of the triblock copolymer 2 are the same as those of the triblock copolymer 1 obtained in Example 1.

A transparent conductive film with a pressure-sensitive adhesive layer was prepared, and subsequent patterning and crystallization were performed in the same manner as in Example 1 except that the triblock copolymer 2 prepared as described above was used in place of the triblock copolymer 1 in Example 1.

### Comparative Example 1

### Preparation of Acryl-Based Polymer

To a reaction vessel equipped with a cooling pipe, a nitrogen inlet, a thermometer and a stirrer, 100 parts of butyl acrylate, 2 parts of acrylic acid, 5 parts of vinyl acetate and 0.2 parts of 2,2′-azobisisobutyronitrile were added together with ethyl acetate, the resulting mixture was reacted at 55° C. for 10 hours under a nitrogen gas flow, and ethyl acetate was then added to the reaction liquid to obtain a solution (solid concentration: 30%) containing an acryl-based polymer having a weight average molecular weight of 2200000 (hereinafter, also referred to as “an acryl-based polymer solution (II)”).

(Preparation of Pressure-Sensitive Adhesive)

Uniformly mixed and stirred was 1 part of an adduct body of trimethylolpropane/tolylenediisocyanate as an isocyanate-based crosslinking agent (product name “CORONATE L” manufactured by Nippon Polyurethane Industry Co., Ltd.) with respect to 100 parts by solid content of the acryl-based polymer solution (II) to prepare an acryl-based pressure-sensitive adhesive solution (solid content: 10.9% by weight).

(Formation of Pressure-Sensitive Adhesive Layer)

The acryl-based pressure-sensitive adhesive was applied onto a separator formed of a release-treated polyester film (thickness of 38 μm) by a reverse coating method so that a dried pressure-sensitive adhesive layer had a thickness of 25 μm, and the applied adhesive was heated at 150° C. for 3 minutes to volatilize the solvent, thereby obtaining the pressure-sensitive adhesive layer.

<Preparation of Transparent Conductive Film with a Pressure-Sensitive Adhesive Layer, Etc.>

A transparent conductive film with a pressure-sensitive adhesive layer was prepared, and subsequent patterning and crystallization were performed in the same manner as in Example 1 except that the pressure-sensitive adhesive layer formed as described above was used as a pressure-sensitive adhesive layer in Example 1.

### Comparative Example 2

### Preparation of Polymer Forming Pressure-Sensitive Adhesive Layer

A triblock copolymer 3 of PMMA-PnBA-PMMA was obtained in the same manner as in Example 1 except that the weight ratio of monomer units was changed to nBA/MMA=50/50. The ratios of PMMAs at both sides are the same. The weight average molecular weight (Mw), number average molecular weight (Mn) and molecular weight distribution (Mw/Mn) of the triblock copolymer 3 are the same as those of the triblock copolymer 1 obtained in Example 1.

A transparent conductive film with a pressure-sensitive adhesive layer was prepared, and subsequent patterning and crystallization were performed in the same manner as in Example 1 except that the triblock copolymer 3 prepared as described above was used in place of the triblock copolymer 1 in Example 1.

### Comparative Example 3

A transparent conductive film with a pressure-sensitive adhesive layer was prepared, and subsequent patterning and crystallization were performed in the same manner as in Example 1 except that the thickness of the pressure-sensitive adhesive layer was changed from 25 μm to 300 μm in Example 1.

### Comparative Example 4

A transparent conductive film with a pressure-sensitive adhesive layer was prepared, and subsequent patterning and crystallization were performed in the same manner as in Comparative Example 1 except that a PET film having a thickness of 100 μm was used in place of the PET film having a thickness of 25 μm as a film base in Comparative Example 1.

<Evaluation>

Evaluations were performed as described below for transparent conductive films with a pressure-sensitive adhesive layer obtained in Examples and Comparative Examples. The results are shown in Table 1. The thicknesses of the film base and the pressure-sensitive adhesive layer, and the total thickness thereof are shown together in Table 1.

<<Storage Modulus>>

For the pressure-sensitive adhesive layer formed on the separator, the storage modulus was determined by the following method.

[Method for Measurement of Storage Modulus]

The storage modulus was measured using a viscoelasticity spectrometer (product name: RSA-II) manufactured by Rheometric Co. Measurement conditions included a frequency of 1 Hz, a sample thickness of 2 mm, a contact bonding load of 100 g and a temperature elevation rate of 5° C./min, and a value obtained at 23° C. in a range of −50° C. to 200° C. was employed as a measurement value.

<<Visual Evaluation of Level Differences>>

The separator was removed from the transparent conductive film with a pressure-sensitive adhesive layer, the film was bonded, on the side of the pressure-sensitive adhesive layer, to a glass plate, and the article thus obtained was used as a sample. The sample was placed such that the patterned transparent conductive layer of the transparent conductive film with a pressure-sensitive adhesive layer was arranged to be the upper side, and evaluations were performed by visual observation. For evaluation, whether or not the patterned part and the non-patterned part could be discriminated from each other was determined in accordance with the criteria described below. The distance of visual observation was 20 cm, and the angle of visual observation was 40 degrees with respect to the plane of the sample.

⊙: the patterned part and the non-patterned part can be hardly discriminated from each other.
◯: the patterned part and the non-patterned part can be slightly discriminated from each other.
Δ: the patterned part and the non-patterned part can be discriminated from each other.
x: the patterned part and the non-patterned part can be clearly discriminated from each other.

<<Adhesion Strength>>

After the separator was removed from the transparent conductive film with a pressure-sensitive adhesive layer, the adhesion of the pressure-sensitive adhesive layer was evaluated by means of finger touch in accordance the criteria described below.

◯: a tacky feeling as a pressure-sensitive adhesive is present

x: no tacky feeling

TABLE 1

| | Pressure-sensitive | | | | | |
|---|---|---|---|---|---|---|
| | adhesive layer | | Thickness | Total | Evaluation | |
| | Storage | Thickness | of film | thickness | Level | |
| | modulus [Pa] | [μm] | base [μm] | [μm] | differences | Adhesion |
| Example 1 | 8.1 × 10⁵ | 25 | 25 | 50 | ◯ | ◯ |
| Example 2 | 8.1 × 10⁵ | 25 | 50 | 75 | ◯ | ◯ |
| Example 3 | 8.1 × 10⁵ | 25 | 75 | 100 | ⊙ | ◯ |
| Example 4 | 8.1 × 10⁵ | 25 | 100 | 125 | ⊙ | ◯ |
| Example 5 | 8.1 × 10⁵ | 150 | 75 | 225 | ◯ | ◯ |
| Example 6 | 2.3 × 10⁵ | 25 | 25 | 50 | ◯ | ◯ |
| Example 7 | 7.0 × 10⁶ | 25 | 25 | 50 | ⊙ | Δ |
| Comparative | 1.0 × 10⁵ | 25 | 25 | 50 | X | ◯ |
| Example 1 | | | | | | |
| Comparative | 2.0 × 10⁷ | 25 | 25 | 50 | ⊙ | X |
| Example 2 | | | | | | |
| Comparative | 8.1 × 10⁵ | 300 | 25 | 325 | X | ◯ |
| Example 3 | | | | | | |
| Comparative | 1.0 × 10⁵ | 25 | 100 | 125 | Δ | ◯ |
| Example 4 | | | | | | |

### DESCRIPTION OF REFERENCE SIGNS

1 film base
2 transparent conductive layer
a patterned part
b non-patterned part
3 pressure-sensitive adhesive layer
4 undercoat layer
S separator
G oligomer prevention layer
11, 12, 13, 14, 15 transparent conductive film with a pressure-sensitive adhesive layer
F functional layer
W window

1. A transparent conductive film with a pressure-sensitive adhesive layer, which is for use in a capacitive touch panel, comprising:
a film base,
a transparent conductive layer laminated on one surface of the film base and which is patterned; and
a pressure-sensitive adhesive layer laminated on the other surface of the film base,
wherein the film base has a thickness of 10 to 110 μm,
a total thickness of the film base and the pressure-sensitive adhesive layer is 30 to 300 μm, and
the pressure-sensitive adhesive layer has a storage modulus measured at 23° C. of 1.2×10⁵ or more and less than 1.0×10⁷ Pa.

2. The transparent conductive film with a pressure-sensitive adhesive layer according to claim 1, wherein the transparent conductive layer is laminated on the film base with at least one undercoat layer interposed therebetween.

3. The transparent conductive film with a pressure-sensitive adhesive layer according to claim 1, wherein the pressure-sensitive adhesive layer is laminated on the film base with an oligomer prevention layer interposed therebetween.

4. The transparent conductive film with a pressure-sensitive adhesive layer according to claim 1, wherein the patterned transparent conductive layer is crystallized.

5. A method for producing the transparent conductive film with a pressure-sensitive adhesive layer according to claim 1, comprising:
a step A of providing a laminated body which has a transparent conductive layer laminated on one surface of a film base having a thickness of 10 to 110 μm and which has on the other surface of the film base a pressure-sensitive adhesive layer which has a storage modulus measured at 23° C. of 1.2×10⁵ or more and less than 1.0×10⁷ Pa and which is controlled so that a total thickness of the film base and the pressure-sensitive adhesive layer is 30 to 300 μm; and
a step B of patterning the transparent conductive layer in the laminated body obtained in the step A.

6. The method for producing the transparent conductive film with a pressure-sensitive adhesive layer according to claim 5, further comprising a step C of heating the laminated body obtained in the step A at 60 to 200° C. to crystallize the transparent conductive layer in the laminated body.

7. The method for producing the transparent conductive film with a pressure-sensitive adhesive layer according to claim 6, wherein the crystallization step C is carried out after the step B of patterning the laminated body obtained in the step A is carried out.

8. A capacitive touch panel comprising at least one transparent conductive film with a pressure-sensitive adhesive layer according to claim 1.

9. A method for producing the transparent conductive film with a pressure-sensitive adhesive layer according to claim 2, comprising:
a step A of providing a laminated body which has a transparent conductive layer laminated on one surface of a film base having a thickness of 10 to 110 μm and which has on the other surface of the film base a pressure-sensitive adhesive layer which has a storage modulus measured at 23° C. of 1.2×10⁵ or more and less than 1.0×10⁷ Pa and which is controlled so that a total thickness of the film base and the pressure-sensitive adhesive layer is 30 to 300 μm; and
a step B of patterning the transparent conductive layer in the laminated body obtained in the step A.

10. A method for producing the transparent conductive film with a pressure-sensitive adhesive layer according to claim 3, comprising:
a step A of providing a laminated body which has a transparent conductive layer laminated on one surface of a film base having a thickness of 10 to 110 μm and which has on the other surface of the film base a pressure-sensitive adhesive layer which has a storage modulus measured at 23° C. of 1.2×10⁵ or more and less than 1.0×10⁷ Pa and which is controlled so that a total thickness of the film base and the pressure-sensitive adhesive layer is 30 to 300 μm; and
a step B of patterning the transparent conductive layer in the laminated body obtained in the step A.

11. A capacitive touch panel comprising at least one transparent conductive film with a pressure-sensitive adhesive layer according to claim 2.

12. A capacitive touch panel comprising at least one transparent conductive film with a pressure-sensitive adhesive layer according to claim 3.

13. A capacitive touch panel comprising at least one transparent conductive film with a pressure-sensitive adhesive layer according to claim 4.
